(19) United States
(12) Patent Application Publication
(10) Pub. No.: US 2004/0184821 A1
(43) Pub. Date: Sep. 23, 2004

(54) Optical preamplifier with received signal strength indicating function

(76) Inventor: Phillip J. Edwards, San Jose, CA (US)

Correspondence Address: ROBERT A. PARSONS, 340 E. PALM LN, SUITE 260, PHOENIX, AZ, 85004, US

(21) Appl. No.: 10/716,345

(22) Filed: Nov. 18, 2003

Related U.S. Application Data
(60) Provisional application No. 60/427,439, filed on Nov. 19, 2002.

(51) Int. Cl. H04B 10/06

(52) U.S. Cl. 398/202

(57) ABSTRACT

An optical preamplifier with received signal strength indicating function is disclosed that dose not increase the number of terminals. The preamplifier includes an amplifier stage having cascaded amplifiers and a current mode output stage with Darlington pair transistors. The amplifier stage has a signal input to the cascaded amplifiers, two signal output terminals from the Darlington pair transistors, a power input terminal, and a return terminal. A PIN photodiode has one terminal coupled to the signal input of the amplifier stage and a second terminal coupled through a resistance to one of the two signal output terminals so as to provide the received signal strength indicating function between the two signal output terminals.

### CROSS-REFERENCE TO RELATED APPLICATIONS

This application claims the benefit of U.S. Provisional Application No. 60/427,439, filed 19 Nov. 2002.

### FIELD OF THE INVENTION

This invention relates to optical preamplifiers and, more particularly, to optical preamplifiers including received signal strength indications or indicators.

### BACKGROUND OF THE INVENTION

Optoelectronics is a rapidly expanding technology that is an important component in modern communications systems wherein it is desired to transmit vast amounts of data over long distances in a short period of time. With the increasing commercial applications for optoelectronic systems, there is a need to develop cost effective and reliable optoelectronic devices for use in optical communications systems.

Typical fiber optic systems include an optical preamplifier which detects incident light from an optical fiber and converts the light into an amplified electrical signal. In one application, the incident light is incident onto a PIN photodiode which is electrically connected to the preamplifier. It is desirable, however, to be able to measure the intensity of the light incident onto the PIN photodiode. This can be accomplished by using a received signal strength indicator (hereinafter referred to as “RSSI”). The RSSI typically includes a resistor electrically connected in series with the PIN photodiode wherein the current through the PIN photodiode can be measured at an outside lead to measure the intensity of the incident light. This solution can be accomplished by increasing the number of leads required for the system. It is well known by those skilled in the art, however, that increasing the number of leads increases the system cost and complexity. Thus, it is desirable to add the RSSI function to the optical preamplifier without increasing the number of leads.

It would be highly advantageous, therefore, to remedy the foregoing and other deficiencies inherent in the prior art.

Accordingly, it is an object the present invention to provide a new and improved optical preamplifier with a received signal strength indicator function.

Another object of the present invention is to provide a new and improved optical preamplifier having a received signal strength indicator function with reduced cost and complexity.

Another object of the present invention is to provide a new and improved optical preamplifier including a received signal strength indicator function, with fewer leads.

### SUMMARY OF THE INVENTION

Briefly, to achieve the desired objects of the instant invention in accordance with a preferred embodiment thereof, an optical preamplifier with received signal strength indicating function is disclosed. The optical preamplifier includes an amplifier stage having a signal input, two signal output terminals, a power input terminal, and a return terminal. A photodiode has one terminal coupled to the signal input of the amplifier stage and a second terminal coupled through a resistance to one of the two signal output terminals so as to provide the received signal strength indicating function between the two signal output terminals.

In one embodiment, an optical preamplifier with received signal strength indicating function is disclosed that dose not increase the number of terminals. The preamplifier includes an amplifier stage having cascaded amplifiers and a current mode output stage with Darlington pair transistors. The amplifier stage has a signal input to the cascaded amplifiers, two signal output terminals from the Darlington pair transistors, a power input terminal, and a return terminal. A PIN photodiode has one terminal coupled to the signal input of the amplifier stage and a second terminal coupled through a resistance to one of the two signal output terminals so as to provide the received signal strength indicating function between the two signal output terminals.

The desired objects of the instant invention are further realized in method of providing an optical preamplifier with a received signal strength indicating function without increasing the number of leads. The method includes the steps of: providing an amplifier stage having a signal input, two signal output terminals, a power input terminal, and a return terminal; coupling one terminal of a photodiode to the signal input of the amplifier stage; and coupling a second terminal of the photodiode through a resistance to one of the two signal output terminals so as to provide the received signal strength indicating function between the two signal output terminals.

### BRIEF DESCRIPTION OF THE DRAWINGS

The foregoing and further and more specific objects and advantages of the instant invention will become readily apparent to those skilled in the art from the following detailed description of a preferred embodiment thereof taken in conjunction with the drawings, in which:

FIG. 1 is a circuit schematic of a preamplifier with four leads, wherein the preamplifier is electrically connected to a PIN photodiode;

FIG. 2 is a circuit schematic of a preamplifier with five leads which includes a received signal strength indicator, wherein the preamplifier is electrically connected to a PIN photodiode;

FIG. 3 is a more detailed circuit schematic of the preamplifier of FIG. 1, with four leads;

FIG. 4 is a circuit schematic of a preamplifier with four leads which includes a received signal strength indicator, wherein the preamplifier is electrically connected to the photodiode, in accordance with the present invention; and

FIG. 5 is a more detailed circuit schematic of a preamplifier, with four leads including the received signal strength indicator, in accordance with the present invention.

### DETAILED DESCRIPTION OF THE DRAWINGS

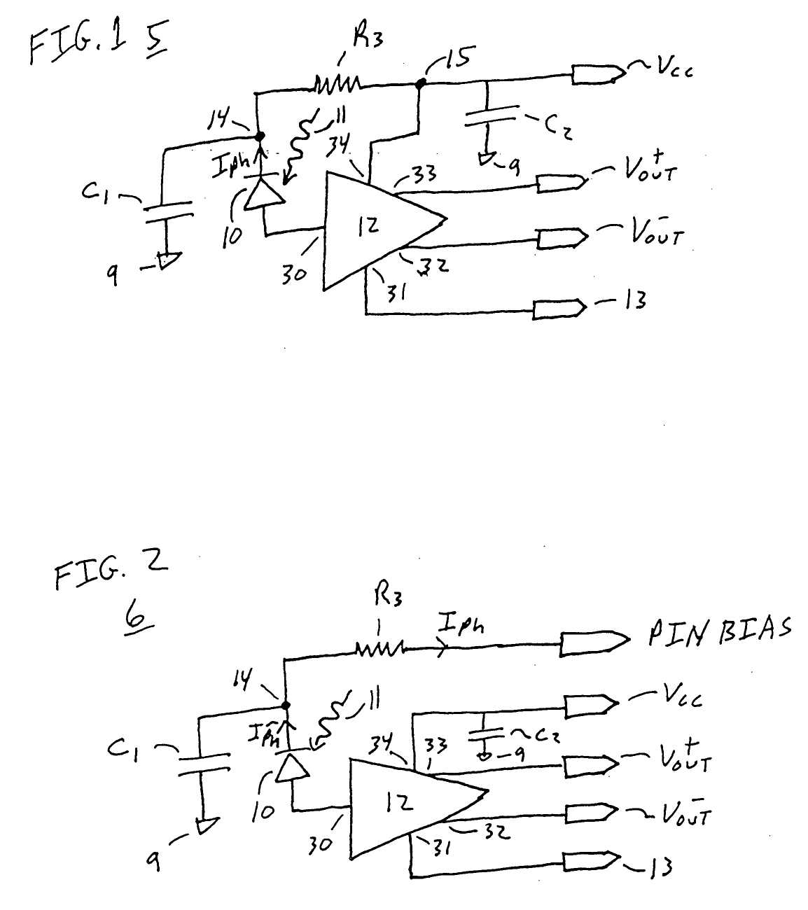

Turning now to FIG. 1, a simplified circuit schematic of an optical preamplifier 5 is illustrated. Here it will be understood that FIGS. 1, 2, and 3 are included to aid in providing an example of individual components and problems encountered in the field of the present invention and solved in the present invention. Preamplifier 5 includes an amplifier 12 with an input connection 30, a positive voltage output connection 33, a negative voltage output connection 32, a current return connection 31, and a power connection 34. Current return connection 31 is electrically connected to a current return lead 13, positive voltage output connection 33 is electrically connected to a lead Vₒᵤₜ⁺, negative voltage output connection 32 is electrically connected to a lead Vₒᵤₜ⁻, and power connection 34 is electrically connected to a lead V_{cc} at a node 15. Vₒᵤₜ⁺ and Vₒᵤₜ⁻ are typically RF coupled to a current limiting amplifier (not shown). It will be understood that optical preamplifier 5 is typically formed as an integrated circuit on a chip and that current return lead 13, lead Vₒᵤₜ⁺, and lead Vₒᵤₜ⁻ provide a means for electrical communication outside of the chip.

Input connection 30 is electrically connected to a terminal of a PIN photodiode 10. PIN photodiode 10 is used to detect light 11 from an optical fiber (not shown) or the like wherein light 11 creates a photocurrent, I_{PH}. It is desirable to convert light 11 into an electrical signal externally available between leads Vₒᵤₜ⁺ and Vₒᵤₜ⁻. An opposed terminal of PIN photodiode 10 is electrically connected to a terminal of a capacitor, C₁, and a terminal of a resistor, R₃, at a node 14. An opposed terminal of C₁ is electrically connected to a current return 9. An opposed terminal of R₃ is electrically connected to lead V_{CC} at node 15. A terminal of a capacitor, C₂, is electrically connected to node 15 and an opposed terminal of C₂ is electrically connected to current return 9. Lead V_{cc} provides a means for electrical communication with an electrical power source (not shown) to power optical preamplifier 5.

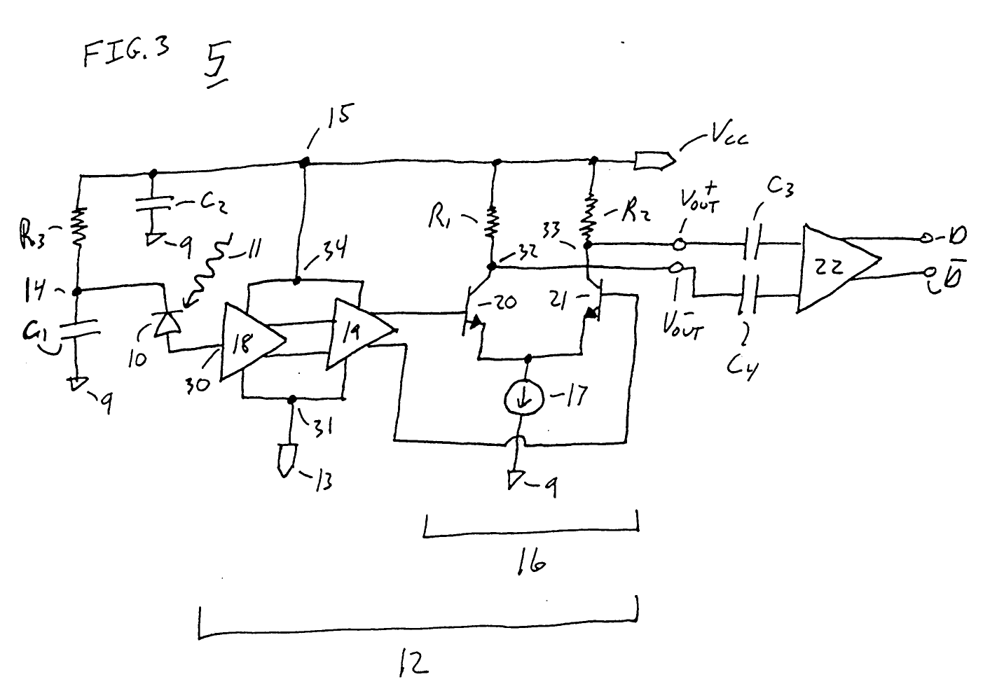

Turn now to FIG. 2 which illustrates a simplified circuit schematic of an optical preamplifier 6 which includes a received signal strength indicator (RSSI) . Preamplifier 6 is electrically connected to a PIN photodiode 10 in a similar manner to preamplifier 5 except a PIN BIAS lead has been added. The PIN BIAS lead is connected to provide an indication of the photocurrent, I_{PH}, of PIN photodiode 10 so that an intensity of light 11 can be measured. Thus, the PIN BIAS lead acts as a received signal strength indicator. Unfortunately, this solution to the RSSI measurement requires the addition of an extra lead (i.e. the PIN BIAS lead). It is well known by those skilled in the art that the addition of extra leads into a chip package increases the cost and complexity of the system. Thus, it is desirable to have a preamplifier circuit with fewer leads that has the RSSI feature.

Turn now to FIG. 3 which illustrates a more detailed circuit schematic of optical preamplifier circuitry 5 without an RSSI feature, including a preamplifier stage 12. Preamplifier stage 12 includes cascaded amplifiers, such as amplifier 18 and amplifier 19 to achieve a desired gain and frequency response. Preamplifier stage 12 also includes a current mode logic output stage 16 which includes Darlington pair transistors 20 and 21 electrically connected to a current source 17. A resistor, R₁, is electrically connected between transistor 20 and V_{cc} and a resistor, R₂, is electrically connected between transistor 21 and V_{cc}. Also, Vₒᵤₜ⁺ and Vₒᵤₜ⁻ are electrically connected to a RF coupled current limiting amplifier 22 through a capacitor, C₃, and a capacitor, C₄, respectively. Current limiting amplifier 22 includes an output D and an output \overline{D}.

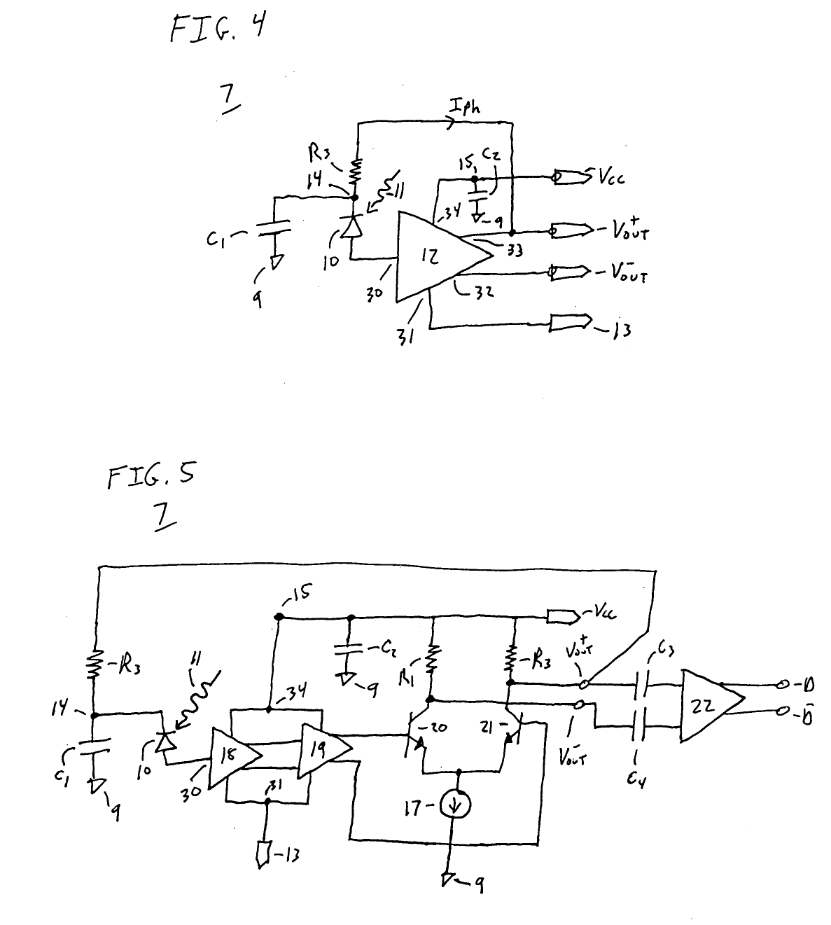

Turn now to FIG. 4 which illustrates a simplified circuit schematic of a preamplifier 7 electrically connected to a photodiode 10, such as a PIN diode or the like, in accordance with the present invention. Also, a more detailed circuit schematic of preamplifier 7 is illustrated in FIG. 5. Preamplifier 7 includes an amplifier 12 with an input connection 30, a positive voltage output connection 33, a negative voltage output connection 32, a current return connection 31, and a power connection 34. Current return connection 31 is electrically connected to a current return lead 13, positive voltage output connection 33 is electrically connected to a lead Vₒᵤₜ⁺, negative voltage output connection 32 is electrically connected to a lead Vₒᵤₜ⁻, and power connection 34 is electrically connected to a lead V_{cc} at a node 15. Vₒᵤₜ⁺ and Vₒᵤₜ⁻ are typically RF coupled to a current limiting amplifier (not shown). In this embodiment, a terminal of a resistance R₃ (e.g. a resistor or any device that provides the resistance for the sensing operation) is electrically connected to a node 14 and the opposed terminal of resistance R₃ is electrically connected to lead Vₒᵤₜ⁺.

In preamplifier 7, an RSSI output is sensed by measuring the DC offset between leads Vₒᵤₜ⁺ and Vₒᵤₜ⁻. Thus, the RSSI feature has been included in this embodiment without increasing the number of leads. This is especially important when preamplifier 7 is fabricated as an integrated circuit. The use of fewer leads in preamplifier 7 reduces the cost and allows a simpler implementation and an improved performance. For example, this embodiment allows a more linear voltage between Vₒᵤₜ⁺ and Vₒᵤₜ⁻.

Turn now to FIG. 5 which illustrates a more detailed circuit schematic of optical preamplifier circuitry 7 with an RSSI feature and including a preamplifier stage. The preamplifier stage includes cascaded amplifiers 18 and 19 designed to achieve a desired gain and frequency response for a specific application. The preamplifier stage also has a current mode logic output stage including Darlington pair transistors 20 and 21 having a common emitter connection electrically coupled to a current source 17. A resistor, R₁, is electrically connected between transistor 20 and V_{cc} and a resistor, R₂, is electrically connected between transistor 21 and V_{cc}. Also, Vₒᵤₜ⁺ and Vₒᵤₜ⁻ are electrically connected to a RF coupled current limiting amplifier 22 through a capacitor, C₃, and a capacitor, C₄, respectively. Current limiting amplifier 22 includes an output D and an output \overline{D}.

As illustrated in this detail, the anode of photodiode 10 is coupled to input 30 of cascaded amplifiers 18 and 19 and the cathode is connected to node 14. One terminal of a resistance R₃ is connected to node 14 and the other terminal is connected to lead Vₒᵤₜ⁺. One terminal of a capacitor, C₁ is connected to node 14 and the other terminal is connected to a current return 9. Thus, the RSSI output appears as a DC offset between leads Vₒᵤₜ⁺ and Vₒᵤₜ⁻. This DC offset is available for measurement at output D and an output \overline{D} of current limiting amplifier 22. Therefore, the RSSI feature has been included in this embodiment without increasing the number of leads. The use of fewer leads in preamplifier 7 reduces the cost and allows a simpler implementation and an improved performance, especially in an integrated circuit form.

Thus, a new and improved optical preamplifier with a received signal strength indicator function is disclosed. The new and improved optical preamplifier with a received signal strength indicator function is provided with reduced cost and complexity, as a result of the preamplifier requiring fewer leads. Reducing the number of leads in the optical preamplifier substantially improves the production and use, especially in an integrated form.

Various changes and modifications to the embodiments herein chosen for purposes of illustration will readily occur to those skilled in the art. To the extent that such modifications and variations do not depart from the spirit of the invention, they are intended to be included within the scope thereof which is assessed only by a fair interpretation of the following claims.

Having fully described the invention in such clear and concise terms as to enable those skilled in the art to understand and practice the same, the invention claimed is:

1. An optical preamplifier with received signal strength indicating function comprising:
an amplifier stage having a signal input, two signal output terminals, a power input terminal, and a return terminal; and
a photodiode having one terminal coupled to the signal input of the amplifier stage and a second terminal coupled through a resistance to one of the two signal output terminals so as to provide the received signal strength indicating function between the two signal output terminals.

2. An optical preamplifier with received signal strength indicating function as claimed in claim 1 wherein the received signal strength indicating function between the two signal output terminals appears as a DC offset.

3. An optical preamplifier with received signal strength indicating function as claimed in claim 1 wherein the photodiode is a PIN diode.

4. An optical preamplifier with received signal strength indicating function as claimed in claim 1 wherein the optical preamplifier is formed as an integrated circuit.

5. An optical preamplifier with received signal strength indicating function as claimed in claim 1 wherein the resistance is a resistor.

6. An optical preamplifier with received signal strength indicating function comprising:
an amplifier stage including cascaded amplifiers and a current mode output stage with Darlington pair transistors, the amplifier stage having a signal input to the cascaded amplifiers, two signal output terminals from the Darlington pair transistors, a power input terminal, and a return terminal; and
a PIN photodiode having one terminal coupled to the signal input of the amplifier stage and a second terminal coupled through a resistance to one of the two signal output terminals so as to provide the received signal strength indicating function between the two signal output terminals.

7. An optical preamplifier with received signal strength indicating function as claimed in claim 6 further including a dual input current limiting amplifier having the dual inputs coupled to two signal output terminals of the Darlington pair transistors.

8. A method of providing an optical preamplifier with a received signal strength indicating function without increasing the number of leads comprising the steps of:
providing an amplifier stage having a signal input, two signal output terminals, a power input terminal, and a return terminal; and
coupling one terminal of a photodiode to the signal input of the amplifier stage; and
coupling a second terminal of the photodiode through a resistance to one of the two signal output terminals so as to provide the received signal strength indicating function between the two signal output terminals.

9. A method as claimed in claim 8 including a step of measuring the received signal strength indicating function as a DC offset between the two signal output terminals.
